(19) United States
(12) Patent Application Publication
(10) Pub. No.: US 2023/0311371 A1
(43) Pub. Date: Oct. 5, 2023

(54) REINFORCED SYNTHETIC PRODUCT WITH CURVED GEOMETRY

(71) Applicant: SRAM, LLC, Chicago, IL (US)

(72) Inventors: Chen Hsiung CHEN, Taichung City (TW); Chia Chang CHANG, Taichung City (TW); Huan Ching HSU, Taichung City (TW); Ching Han LIU, Taichung City (TW); Chu Chen WANG, Taichung City (TW)

(73) Assignee: SRAM, LLC, Chicago, IL (US)

(21) Appl. No.: 18/161,308

(22) Filed: Jan. 30, 2023

Related U.S. Application Data
(60) Provisional application No. 63/308,721, filed on Feb. 10, 2022.

(51) Int. Cl. B29C 43/00; B29C 43/02

(52) U.S. Cl. CPC B29C 43/003; B29C 43/02; B29K 2105/0845

(57) ABSTRACT

Disclosed is a method for manufacturing a reinforced synthetic product with a curved geometry, which includes forming a fabric made of at least one filament bundle including a reinforcing fiber material and at least one thermoplastic filament woven with the filament bundle; and combining a heat-formable material with the fabric to form a bendable fabric preform sheet. Also disclosed is a method for manufacturing a reinforced synthetic product with a curved geometry, which includes positioning the bendable fabric preform sheet into a mold with a curved geometry to form a bended fabric preform sheet; and molding the bended fabric preform sheet by heating to form a cured product.

This application claims the benefit of U.S. Provisional Pat. Application number 63/308,721, filed Feb. 10, 2022, which is hereby incorporated by reference in its entirety.

### FIELD

The disclosure relates to a method for manufacturing a reinforced synthetic product, and more particularly to a method for manufacturing a reinforced synthetic product with a curved geometry.

### BACKGROUND

Since thermoplastic resin is solid in a natural state, it is relatively difficult to impregnate reinforcing fibers or filaments (for example, glass or carbon fibers) with the thermoplastic resin to make a reinforced thermoplastic resin. In a conventional method for manufacturing the reinforced thermoplastic resin, the thermoplastic resin is heated to a melting point thereof to form molten thermoplastic resin, and reinforcing fibers or filaments are impregnated with the molten thermoplastic resin under pressure to obtain a composite. The composite is then cooled under the pressure to obtain the reinforced thermoplastic resin.

In addition, the reinforced thermoplastic resin is usually in a form of a solid sheet. Therefore, the reinforced thermoplastic resin is required to be softened by heating before laminating a plurality of the sheets of the reinforced thermoplastic resin to form a laminate, and then molding the laminate to obtain a molded article. It is also difficult to mold the laminate into a three-dimensional molded article with a complicated profile.

U.S. Pat. No. 7,138,345 B2 discloses a carbon fiber reinforced substrate which includes a fabric composed of carbon fiber bundles and a first resin adhering to the fabric, a preform which includes a laminate composed of plural layers of the carbon fiber reinforced substrate, and a composite which includes the preform impregnated with a matrix resin. Each of the carbon fiber bundles includes numerous continuous carbon filaments having specified tensile modulus and fracture strain energy. This patent document discloses a method for manufacturing the carbon fiber reinforced substrate, and claims the strength performance of the carbon fiber bundles. However, this patent document does not specifically disclose a method for manufacturing a reinforced synthetic product with a curved geometry.

### SUMMARY

Therefore, an object of the disclosure is to provide a method for manufacturing a reinforced synthetic product with a curved geometry in a relatively quick and simple manner without use of complicated equipment.

According to an aspect of the disclosure, there is provided a method for manufacturing a reinforced synthetic product with a curved geometry, which includes:
forming a fabric having a woven pattern which is made of at least one filament bundle including a reinforcing fiber material and at least one thermoplastic filament woven with the filament bundle; and
combining a heat-formable material with the fabric to form a bendable fabric preform sheet.

According to another aspect of the disclosure, there is provided a method for manufacturing a reinforced synthetic product with a curved geometry, which includes:
positioning a bendable fabric preform sheet into a mold with a curved geometry so as to form a bended fabric preform sheet, the bendable fabric preform sheet including a fabric having a woven pattern which is made of at least one filament bundle including a reinforcing fiber material and at least one thermoplastic filament woven with the filament bundle, and a heat-formable material combined with the fabric; and
molding the bended fabric preform sheet by heating to form a cured product.

### BRIEF DESCRIPTION OF THE DRAWINGS

Other features and advantages of the disclosure will become apparent in the following detailed description of the embodiment(s) with reference to the accompanying drawings, in which:

FIG. 1 is a flow diagram illustrating an embodiment of a method for manufacturing a reinforced synthetic product with a curved geometry according to the disclosure; and

FIGS. 2 to 5 are schematic perspective views showing consecutive steps of the embodiment.

### DETAILED DESCRIPTION

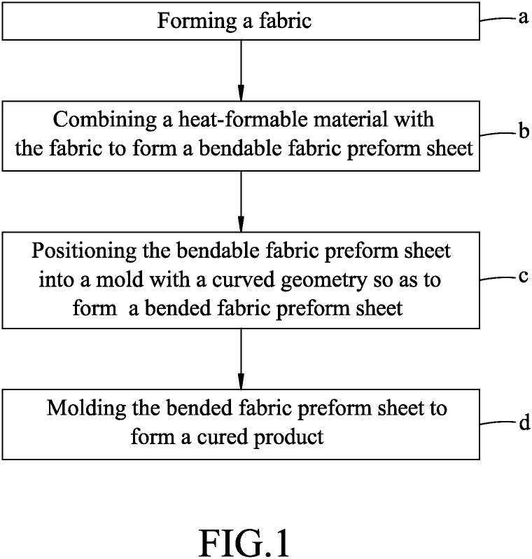

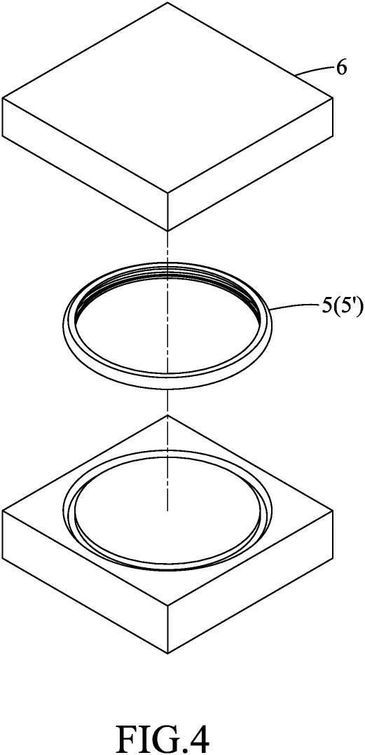

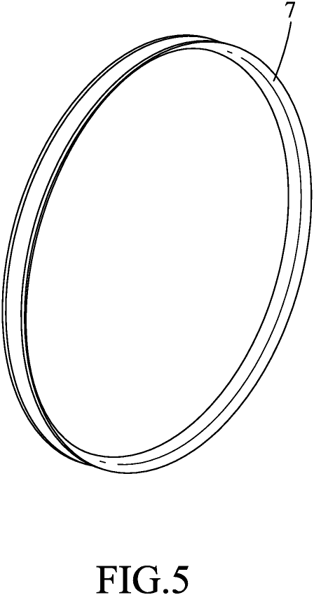

Referring to FIGS. 1 to 5, an embodiment of a method for manufacturing a reinforced synthetic product with a curved geometry according to the disclosure includes the acts of:
a) forming a fabric 1 having a woven pattern which is made of at least one filament bundle 2 including a reinforcing fiber material and at least one thermoplastic filament 3 woven with the filament bundle 2;
b) combining a heat-formable material 4 with the fabric 1 to form a bendable fabric preform sheet 5;
c) positioning the bendable fabric preform sheet 5 into a mold 6 with a curved geometry so as to form a bended fabric preform sheet 5′; and
d) molding the bended fabric preform sheet 5′ by heating to form a cured product 7.

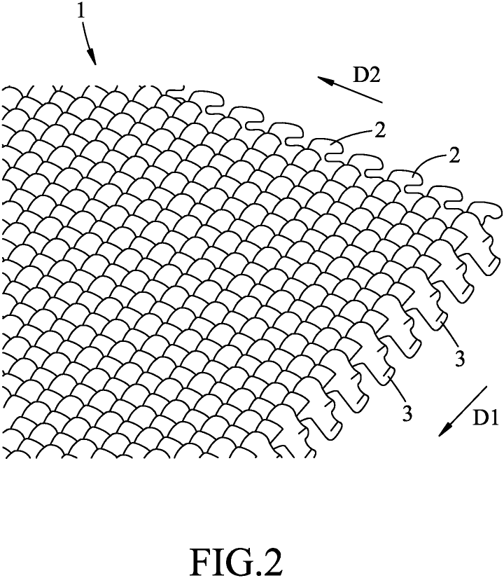

Specifically referring to FIG. 2, the fabric 1 includes a plurality of the filament bundles 2 which extend in a first direction (D1, for example, a warp direction), and a plurality of the thermoplastic filaments 3 which extend in a second direction (D2, for example, a weft direction) transverse to the first direction (D1) and which are woven with the filament bundles 2 to form the woven pattern.

In some embodiments, the reinforcing fiber material of the filament bundles 2 may be, for example, but not limited to, a carbon fiber, a glass fiber, an asphalt fiber, a cellulose fiber, a plant fiber, a mineral fiber, or combinations thereof. In some embodiments, the thermoplastic filaments 3 may be made of a thermoplastic material, which may be, for example, but not limited to, polypropylene, polyamide, polyether ether ketone, polycarbonate, polyethylene, acrylonitrile butadiene styrene, or combinations thereof. In some embodiments, the fabric 1 may include the thermoplastic material in an amount ranging from 3.5 wt% to 15 wt% based on a total weight of the fabric 1. In some embodiments, the amount of the thermoplastic material in the fabric 1 may range from 3.5 wt% to 5 wt% based on the total weight of the fabric 1. When the amount of the thermoplastic material in the fabric 1 is less than a lower limit of the above range, the fabric 1 may be damaged, deformed, or broken easily in the subsequent acts of the method for manufacturing the reinforced synthetic product. When the amount of the thermoplastic material in the fabric 1 is greater than an upper limit of the above range, the amount of the reinforcing fiber material in the fabric 1 is insufficient such that the reinforcing effect of the fabric 1 may be unsatisfactory. In some embodiments, the reinforcing fiber material may be combined with the thermoplastic material to form the filament bundles 2 so as to increase a total amount of the thermoplastic material in the fabric 1.

In some embodiments, the filament bundles 2 includes the reinforcing fiber material in an amount ranging from 1000 filaments to 48000 filaments per filament bundle. In some embodiments, the filament bundles 2 includes the reinforcing fiber material in an amount ranging from 1500 filaments to 24000 filaments per filament bundle. In some embodiments, the filament bundles 2 includes the reinforcing fiber material in an amount ranging from 3000 filaments to 12000 filaments per filament bundle. When the filament bundles 2 includes the reinforcing fiber material in an amount less than the lower limit of the range, the cost for producing the fabric 1 is undesirably increased and the tensile strength of the filament bundles 2 is unsatisfactory such that the filament bundles 2 are easily broken. When the filament bundles 2 includes the reinforcing fiber material in an amount greater than the upper limit of the range, the fabric 1 may not be combined sufficiently with the heat-formable material 4 through impregnation in act b), such that the reinforcing fiber materials in the bendable fabric preform sheet 5 may not bond each other sufficiently through the thermoplastic material.

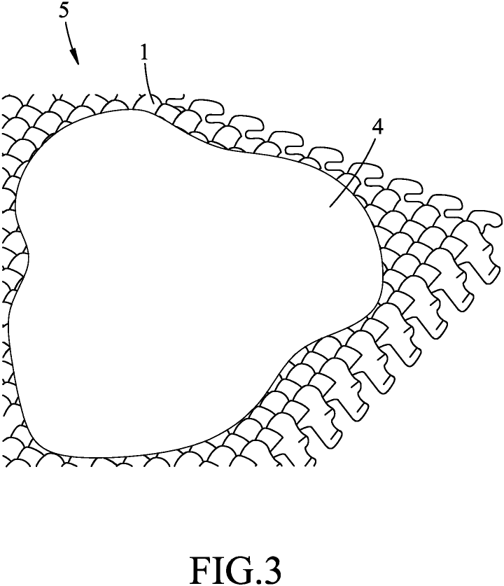

Specifically referring to FIG. 3, in act b), the heat-formable material 4 for combining with the fabric 1 is a thermoplastic material, which may be, for example but not limited to, polypropylene, polyamide, polyether ether ketone, polycarbonate, polyethylene, acrylonitrile butadiene styrene, or combinations thereof. In some embodiments, the thermoplastic material of the heat-formable material 4 is the same as the thermoplastic material of the thermoplastic filaments 3.

In act b), the heat-formable material 4 may be combined with the fabric 1 by a impregnating process, for example, but not limited to, a physical impregnating process, a chemical impregnating process, or a combination thereof, to form the bendable fabric preform sheet 5, which includes the reinforcing fiber materials arranged in an uni-direction and which includes an increased amount of the thermoplastic material in the fabric 1.

Examples of the physical impregnating process may include a hot pressing process, a laminating process, a melt blowing process, a co-extruding process, and combinations thereof, but are not limited thereto. The physical impregnating process may be performed at a temperature higher than a softening point of the heat-formable material 4 and lower than a pyrolysis temperature of the heat-formable material 4. In some embodiments, the temperature for performing the physical impregnating process is not less than a melting point of the heat-formable material 4 by 50° C. and not greater than the melting point of the heat-formable material 4 by 50° C. In some embodiments, the temperature for performing the physical impregnating process is not less than the melting point of the heat-formable material 4 by 30° C. and not greater than the melting point of the heat-formable material 4 by 30° C., so as to effectively melt the heat-formable material 4, enhance the impregnation effect, and increase the bonding effect between the reinforcing fiber materials.

In some embodiments, the thermoplastic material of the heat-formable material 4 used in the physical impregnating process may be in a form of a film, powders, granules, or the like. When the thermoplastic material of the heat-formable material 4 is in a form of a film, the film may be configured as a continuous film or a discontinuous film (for example, a mesh film), and one or more of the films may be combined with the fabric 1. When the thermoplastic material of the heat-formable material 4 is in a form of powders, the powders may have a size ranging from 1 µm to 500 µm. When thermoplastic material of the heat-formable material 4 is in a form of granules, the granules may have a length ranging from 0.5 mm to 150.0 mm and a cross-section size ranging from 1.0 mm to 5.0 mm. In some embodiments, the granules may include a mixture of the thermoplastic material and the reinforcing fiber material, and the thermoplastic material in the mixture is in an amount ranging from 30 wt% to 70 wt% based on a total weight of the mixture. The thickness of the film, the weight of the powders, or the weight of the granules may be adjusted suitably according to the amount of the heat-formable material 4 to be combined with the fabric 1.

In some embodiments, in the physical impregnating process to combine the heat-formable material 4 with the fabric 1, the heat-formable material 4 may be sandwiched between two of the fabrics 1.

In the chemical impregnating process to combine the heat-formable material 4 with the fabric 1, the fabric 1 is immersed in a solution of organic acid containing the heat-formable material 4. In some embodiments, a content of the heat-formable material 4 in the solution may range, for example, but not limited to, from 0.1 wt% to 40.0 wt% based on a total weight of the solution. In some embodiments, the content of the heat-formable material 4 in the solution ranges from 1.0 wt% to 20.0 wt% based on the total weight of the solution. In some embodiments, the content of the heat-formable material 4 in the solution ranges from 1.0 wt% to 10.0 wt% based on the total weight of the solution.

In some embodiments, the chemical impregnating process is performed by immersing the fabric 1 in the solution of the heat-formable material 4 for a time period ranging, for example, but not limited to, from 30 seconds to 30.0 minutes, followed by baking the fabric 1 combined with the heat-formable material 4 for a time period ranging, for example, but not limited to, from 10 minutes to 60 minutes, to evaporate the organic acid.

In some embodiments, suitable additives may be added to the heat-formable material 4 so as to enhance the processing properties (for example, flowability) of the heat-formable material 4. Examples of the additives may include flow aids, lubricants, dispersants, and the like, but are not limited thereto. To be specific, examples of the additives may include fatty acid ester, fatty acid amide, stearic acid, stearate, ethylene vinyl acetate (EVA) wax, oxidized polyethylene wax, ethylene bis-stearamide (EBS) wax, paraffin wax, metal soap, low molecular weight polypropylene, high molecular weight fatty alcohol, and the like, but are not limited thereto.

In act c), since the bendable fabric preform sheet 5 is flexible at room temperature, positioning the bendable fabric preform sheet 5 into the mold 6 may be performed at room temperature to form the bended fabric preform sheet 5′. Therefore, reheating of the bendable fabric preform sheet 5 before positioning into the mold 6 is not necessary. In some embodiment, since the bendable fabric preform sheet 5 is flexible at room temperature, a plurality of the bendable fabric preform sheets 5 may be laminated easily to form a laminate of the bendable fabric preform sheets 5, which is then positioned into the mold 6 to form a laminate of the bended fabric preform sheets 5′ for molding into the cured product 7. The laminate of the bendable fabric preform sheets 5 may be configured with a curved geometry conformal to the curved geometry of the mold 6.

In step d), molding of the bended fabric preform sheet 5′ may be performed at a temperature higher than the softening point of the heat-formable material 4 and lower than the pyrolysis temperature of the heat-formable material 4. In addition, since the bendable fabric preform sheet 5 is flexible at room temperature, there is no specific limitation to the pressure used for molding the bended fabric preform sheet 5′ in the mold 6, and the cured product 7 thus formed may have a three-dimensional structure conformal to a mold cavity of the mold 6. In some embodiments, the cured product 7 may include the thermoplastic material in an amount ranging from 50 wt% to 70 wt% based on a total weight of the cured product 7. When the amount of the thermoplastic material in the cured product 7 is lower than 50 wt%, the reinforcing fiber materials in the cured product 7 may not bond each other sufficiently through the thermoplastic material. When the amount of the thermoplastic material in the cured product 7 is greater than 70 wt%, the mechanical strength of the cured product 7 may not be enhanced sufficiently by the reinforcing fiber materials. In some embodiments, the cured product 7 may include the thermoplastic material in an amount of 60 wt% based on the total weight of the cured product 7. The cured product 7 may be used for manufacturing, for example, but not limited to, a wheel rim, a crank, a derailleur, or the like, of a bicycle.

Examples of the disclosure will be described hereinafter. It is to be understood that these examples are exemplary and explanatory and should not be construed as a limitation to the disclosure.

### Example 1

A fabric having a woven pattern which was made of carbon fibers and polypropylene filaments was subjected to a hot-pressing process with a polypropylene film at a temperature of 200° C. using a hot-pressing machine so as to form a bendable fabric preform sheet. The bendable fabric preform sheet was then positioned in a mold to form a bended fabric preform sheet. The mold was then heated to a temperature of 240° C., which was higher than a melting point of polypropylene and lower than a pyrolysis temperature of polypropylene, followed by molding the bended fabric preform sheet at a pressure of 100 kg/cm² for a time period of 3 minutes and then cooling the mold to a temperature of 50° C. at the same pressure so as to form a cured product. A weight ratio of polypropylene to carbon fibers in the cured product was 60/40.

### Example 2

A fabric having a woven pattern which was made of carbon fibers and polyamide filaments was subjected to a hot-pressing process with a polyamide film at a temperature of 250° C. and at a melt volume-flow rate (MVR) ranging from 15 cm³/10 min to 25 cm³/10 min (measured according to ISO-1133) using a hot-pressing machine so as to form a bendable fabric preform sheet. The bendable fabric preform sheet was then positioned in a mold to form a bended fabric preform sheet. The mold was then heated to a temperature of 290° C., which was higher than a melting point of polyamide and lower than a pyrolysis temperature of polyamide, followed by molding the bended fabric preform sheet at a pressure of 100 kg/cm² for a time period of 3 minutes and then cooling the mold to a temperature of 50° C. at the same pressure so as to form a cured product. A weight ratio of polyamide to carbon fibers in the cured product was 60/40.

### Example 3

A fabric having a woven pattern which was made of carbon fibers and polyamide filaments was subjected to a chemical impregnating process by immersing the fabric in a solution of organic acid containing polyamide (a content of polyamide in the solution: 7.5 wt%) for a time period of 5 minutes, followed by baking the fabric impregnated with polyamide at a temperature of 150° C. for a time period of 10 minutes so as to form a bendable fabric preform sheet. The bendable fabric preform sheet was then positioned in a mold to form a bended fabric preform sheet. The mold was then heated to a temperature of 290° C., which was higher than a melting point of polyamide and lower than a pyrolysis temperature of polyamide, followed by molding the bended fabric preform sheet at a pressure of 100 kg/cm² for a time period of 3 minutes and then cooling the mold to a temperature of 50° C. at the same pressure so as to form a cured product. A weight ratio of polyamide to carbon fibers in the cured product was 60/40.

### Comparative Example 1

The procedures for preparing the cured product of Comparative Example 1 were similar to those of Example 1, except that a weight ratio of polypropylene to carbon fibers in the cured product was 30/70.

### Comparative Example 2

The procedures for preparing the cured product of Comparative Example 1 were similar to those of Example 2, except that a weight ratio of polyamide to carbon fibers in the cured product was 20/80.

### Evaluation

Flexural strength (bending strength) of each of the cured products of Examples 1 to 3 and Comparative Examples 1 and 2 was measured according to ASTM D790. The results are shown in Table 1 below.

TABLE 1

| | Ex. 1 | Ex. 2 | Ex. 3 | Comp. Ex. 1 | Comp. Ex. 2 |
|---|---|---|---|---|---|
| Weight ratio | PP/C* : 60/40 | PA/C : 60/40 | PA/C** : 60/40 | PP/C : 30/70 | PA/C: 20/80 |
| Flexural strength (MPa) | 3.00 | 4.21 | 5.06 | 1.29 | 0.89 |

*: PP/C: a weight ratio of polypropylene to carbon fibers in a cured product
**: PA/C: a weight ratio of polyamide to carbon fibers in a cured product

As shown in Table 1, in Examples 1 to 3, a weight ratio of the thermoplastic material (i.e., polypropylene or polyamide) to the reinforcing fiber material (i.e., carbon fibers) in the cured products is 60/40, and the flexural strengths of the cured products are 3.00 MPa, 4.21 MPa, and 5.06 MPa, respectively. In Comparative Examples 1 and 2, weight ratios of the thermoplastic material (i.e., polypropylene or polyamide) to the reinforcing fiber material (i.e., carbon fibers) in the cured products are 30/70 and 20/80, respectively, and the flexural strengths of the cured products are 1.29 MPa and 0.89 MPa, respectively, which are lower than those of the cured products of Examples 1 to 3.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for manufacturing a reinforced synthetic product with a curved geometry, comprising:
forming a fabric having a woven pattern which is made of at least one filament bundle including a reinforcing fiber material and at least one thermoplastic filament woven with the filament bundle; and
combining a heat-formable material with the fabric to form a bendable fabric preform sheet.

2. The method according to claim 1, wherein the reinforcing fiber material is selected from the group consisting of a carbon fiber, a glass fiber, an asphalt fiber, a cellulose fiber, a plant fiber, a mineral fiber, and combinations thereof.

3. The method according to claim 1, wherein the thermoplastic filament is made of a thermoplastic material selected from the group consisting of polypropylene, polyamide, polyether ether ketone, polycarbonate, polyethylene, acrylonitrile butadiene styrene, and combinations thereof.

4. The method according to claim 3, wherein the fabric includes the thermoplastic material in an amount ranging from 3.5 wt% to 15 wt% based on a total weight of the fabric.

5. The method according to claim 3, wherein the heat-formable material is a thermoplastic material selected from the group consisting of polypropylene, polyamide, polyether ether ketone, polycarbonate, polyethylene, acrylonitrile butadiene styrene, and combinations thereof.

6. The method according to claim 5, wherein the thermoplastic material of the heat-formable material is the same as the thermoplastic material of the thermoplastic filament.

7. The method according to claim 1, wherein the heat-formable material is combined with the fabric by an impregnating process selected from the group consisting of a physical impregnating process, a chemical impregnating process, and a combination thereof.

8. The method according to claim 7, wherein the physical impregnating process is selected from the group consisting of a hot pressing process, a laminating process, a melt blowing process, a co-extruding process, and combinations thereof.

9. The method according to claim 8, wherein the physical impregnating process is performed at a temperature higher than a softening point of the heat-formable material and lower than a pyrolysis temperature of the heat-formable material.

10. The method according to claim 7, wherein the chemical impregnating process is performed by immersing the fabric in a solution of an organic acid containing the heat-formable material, a content of the heat-formable material in the solution ranging from 0.1 wt% to 40.0 wt% based on a total weight of the solution.

11. The method according to claim 1, wherein the filament bundle includes the reinforcing fiber material in an amount ranging from 1000 filaments to 48000 filaments per filament bundle.

12. The method according to claim 1, further comprising:
positioning the bendable fabric preform sheet into a mold with a curved geometry so as to form a bended fabric preform sheet; and
molding the bended fabric preform sheet by heating to form a cured product.

13. The method according to claim 12, wherein the bended fabric preform sheet is molded at a temperature higher than a softening point of the heat-formable material and lower than a pyrolysis temperature of the heat-formable material.

14. A method for manufacturing a reinforced synthetic product with a curved geometry, comprising:
positioning a bendable fabric preform sheet into a mold with a curved geometry so as to form a bended fabric preform sheet, the bendable fabric preform sheet including a fabric having a woven pattern which is made of at least one filament bundle including a reinforcing fiber material and at least one thermoplastic filament woven with the filament bundle, and a heat-formable material combined with the fabric; and
molding the bended fabric preform sheet by heating to form a cured product.

15. The method according to claim 14, wherein the reinforcing fiber material is selected from the group consisting of a carbon fiber, a glass fiber, an asphalt fiber, a cellulose fiber, a plant fiber, a mineral fiber, and combinations thereof.

16. The method according to claim 14, wherein the thermoplastic filament is made of a thermoplastic material selected from the group consisting of polypropylene, polyamide, polyether ether ketone, polycarbonate, polyethylene, acrylonitrile butadiene styrene, and combinations thereof.

17. The method according to claim 16, wherein the fabric includes the thermoplastic material in an amount ranging from 3.5 wt% to 15 wt% based on a total weight of the fabric.

18. The method according to claim 16, wherein the heat-formable material is a thermoplastic material selected from the group consisting of polypropylene, polyamide, polyether ether ketone, polycarbonate, polyethylene, acrylonitrile butadiene styrene, and combinations thereof.

19. The method according to claim 18, wherein the thermoplastic material of the heat-formable material is the same as the thermoplastic material of the thermoplastic filament material.

20. The method according to claim 14, wherein the bended fabric preform sheet is molded at a temperature higher than a softening point of the heat-formable material and lower than a pyrolysis temperature of the heat-formable material.
